(19) United States
(12) Patent Application Publication
(10) Pub. No.: US 2005/0011302 A1
(43) Pub. Date: Jan. 20, 2005

(54) Pedal shaft structure of a bicycle having a second pedaling function

(76) Inventors: Chien-Kuo Wang, Hsinchuang City (TW); Chien-Min Wang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/618,673

(22) Filed: Jul. 15, 2003

(51) Int. Cl. G05G 1/14

(52) U.S. Cl. 74/594.1

(57) ABSTRACT

A pedal shaft structure of a bicycle having a second pedaling function is proposed. A shaft tube of the bicycle has a braking unit and a shaft. Pedals are arranged at two ends of the shaft through cranks. The shaft has a main shaft, a second spring and a pair of bearings. The main shaft has a first shaft, a second shaft, a first bushing and a first spring. The second spring is telescoped at the main shaft and one end thereof is fixed to the second shaft. The pair of bearings are arranged at two ends of the shaft tube and telescoped at two ends of the main shaft. The braking unit comprises an insertion hole formed at the shaft tube, an insertion rod inserted into the insertion hole, a steering component, a steel rope connected between the steering component and the insertion rod.

### FIELD OF THE INVENTION

The present invention relates to a pedal shaft structure of a bicycle having a second pedaling function and, more particularly, to a pedal shaft structure of a bicycle having a common pedaling function of a 360 degrees circular rotation and a special same-up-same-down pedaling function.

### BACKGROUND OF THE INVENTION

Bicycles are a popular tool for leisure and recreation. However, existent bicycles can only be pedaled in a 360-degree circular rotation, which is monotonous and invariant. This may become boring for the rider.

If a shaft having other pedaling functions is directly installed in a shaft tube of the bicycle, the crank head of the bicycle cannot be reduced, hence not conforming to the object of compactness. Moreover, because some parts of the shaft may manifest elasticity fatigue, it is necessary that they be externally adjustable. Otherwise, the shaft must be detached to replace the fatigued objects, resulting in much trouble and inconvenience.

### SUMMARY OF THE INVENTION

The primary object of the present invention is to provide a pedal shaft structure of a bicycle having a second pedaling function to enhance effectively the entertainment ability of the bicycle while maintaining a compact structure.

Another object of the present invention is to provide a pedal shaft structure of a bicycle having a second pedaling function to let the shaft be externally adjustable for convenience.

To achieve the above objects, the present invention provides a pedal shaft structure of a bicycle having a second pedaling function. The bicycle has a shaft tube with a braking unit and a shaft. A crank is arranged at each end of the shaft. A pedal is arranged at the other end of each of the cranks.

The shaft comprises a main shaft, a second spring and a pair of bearings. The main shaft comprises a first shaft having a guide bar, a second shaft having a wedge body, a first bushing having a wedge body and a guide groove, and a first spring. The first bushing is telescoped between the first shaft and the second shaft. The guide bar is embedded in the guide groove. The first spring is telescoped at the first shaft and elastically retained between the first bushing and the first shaft. The two wedge bodies mesh with each other. The second spring is telescoped at the main shaft. One end of the second spring is fixed at the second shaft. The pair of bearings is arranged at two ends of the shaft tube and telescoped at two ends of the main shaft, respectively.

The braking unit comprises an insertion hole formed in the shaft tube, an insertion rod inserted into the insertion hole, a steering component, a steel rope connected between the steering component and the insertion rod. After the insertion rod is inserted into the insertion hole, it can further be inserted into the other end of the second spring and secured.

### BRIEF DESCRIPTION OF THE DRAWINGS

The various objects and advantages of the present invention will be more readily understood from the following detailed description when read in conjunction with the appended drawing, in which:

FIG. 1 is an exploded perspective view of the present invention;

FIG. 2 is an enlarged view of FIG. 1;

FIG. 3 is an exploded plan view of a braking unit of the present invention from the rearview;

FIG. 4 is a perspective assembly view of the present invention before operation;

FIG. 5 is a cross-sectional view along line 5-5 of the shaft tube of FIG. 4;

FIG. 6 is an action diagram of the present invention when the right pedal is just pedaled forwards 180 degrees (during operation);

FIG. 7 is an action diagram of the present invention after the right pedal is pedaled forwards 180 degrees (after operation);

FIG. 8 is a cross-sectional view along line 8-8 of the shaft tube of FIG. 7;

FIG. 9 is a perspective view of the present invention after the two pedals are simultaneously hooked backwards 180 degrees (after operation);

FIG. 10 is a cross-sectional view along line 10-10 of the shaft tube of FIG. 9;

FIG. 11 is a perspective view of the present invention after the two pedals are simultaneously pedaled forwards 180 degrees (after operation); and

FIG. 12 is a cross-sectional view along line 12-12 of the shaft tube of FIG. 11.

### DETAILED DESCRIPTION OF THE PREFERRED EMBODIMENTS

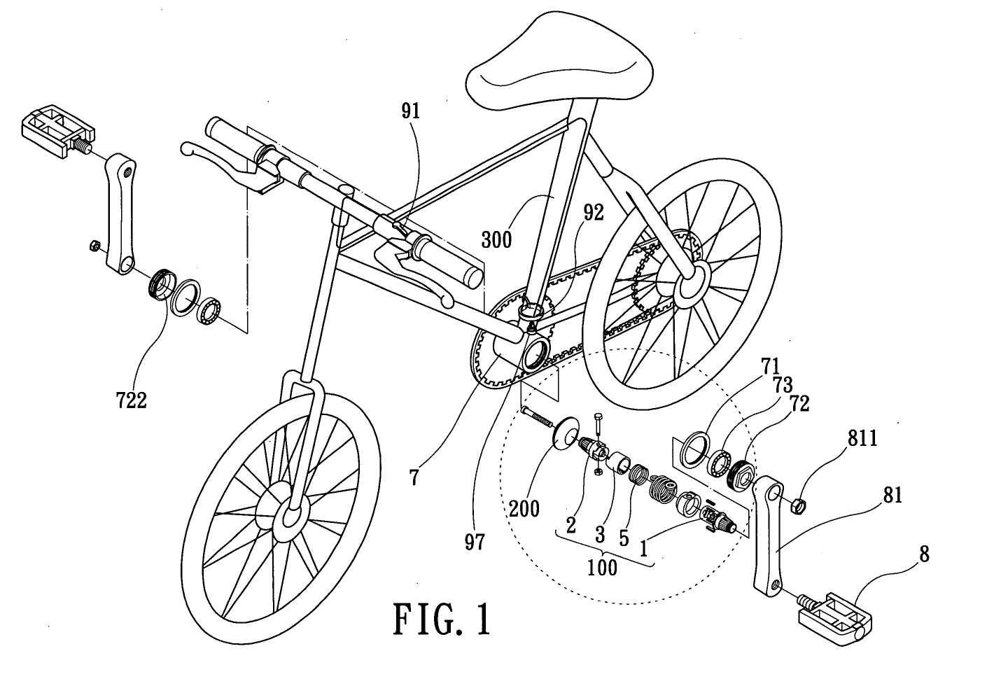

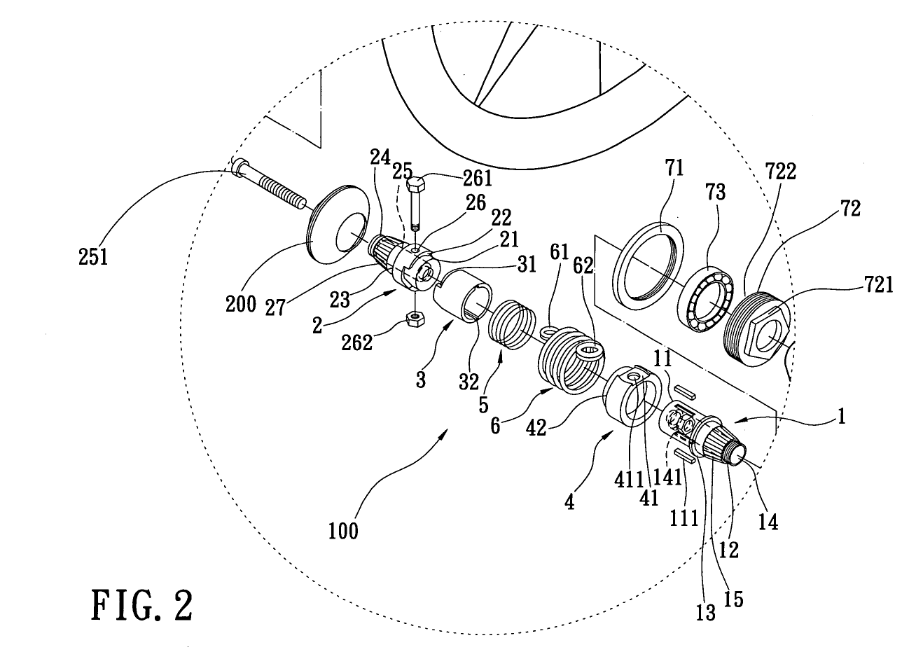

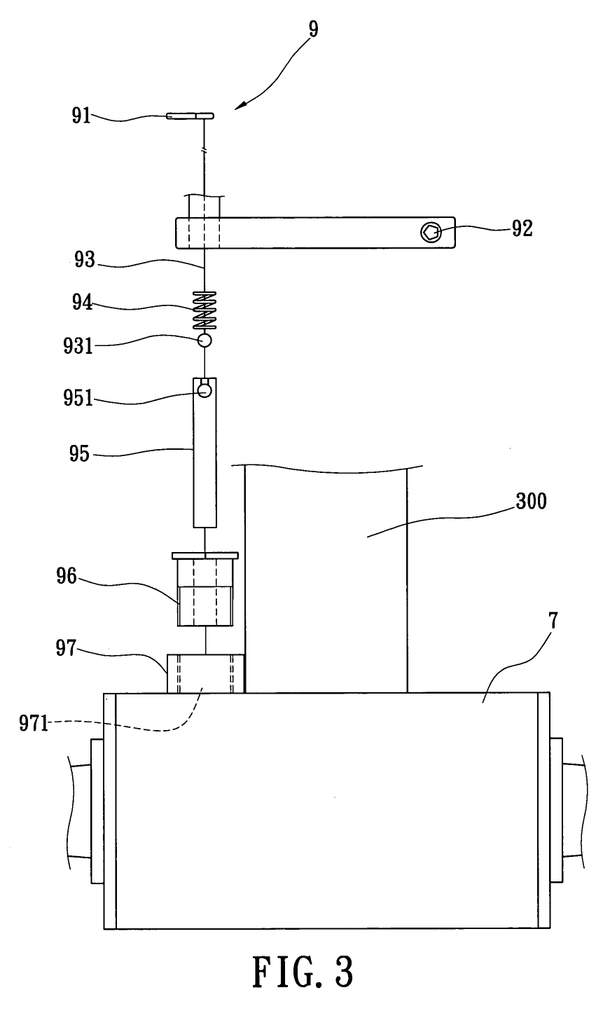

As shown in FIGS. 1 to 12, the present invention provides a pedal shaft structure of a bicycle having a second pedaling function. The bicycle is different from a common bicycle in its shaft, whose two ends are screwed to cranks 81, respectively. The other end of each of the cranks 81 is screwed to a pedal 8. The bicycle has a shaft tube 7 for installation of the shaft and arrangement of a braking unit 9. The shaft comprises a main shaft 100, a second bushing 4, a second spring 6, a fastening ring 71, a side cover 72, and a bearing 73.

As shown in FIGS. 1, 2, 4 and 5, the main shaft 100 comprises a first shaft 1, a second shaft 2, a first bushing 3 and a spring 5. The first shaft installed at the left end of the shaft tube 7 has a first telescoping portion 11, a screwing portion 12 at the outer end of the first shaft 1, a flange 13 formed at the outer edge face of the first shaft, and a receiving room axially formed in the axis of the first shaft 1. A guide bar 111 is embedded in the telescoping portion 11.

The second shaft 2, installed at the right end of the shaft tube 7, has a telescoping portion 21, a wedge body 22 formed on the telescoping portion 21, a screwing portion 24 at the outer end of the second shaft 2, a receiving room 25 axially formed in the axis of the second shaft 2, a through hole axially penetrating the second shaft 2, and a drop portion 23 formed between the wedge body 22 and the screwing portion 24. The wedge body 22 has two wedge-shaped protuberances and two wedge-shaped recessed bodies to mesh with another wedge body 31.

The first bushing 3 has a wedge body 31 formed at the thicker side of one end thereof and a guide groove 32 formed on the inner wall thereof. The wedge body 31 corresponds to the wedge body 22 of the second shaft 2. The guide groove 32 corresponds to the guide bar 111 of the first shaft 1, and is used for translation and never rotation of the first bushing 3

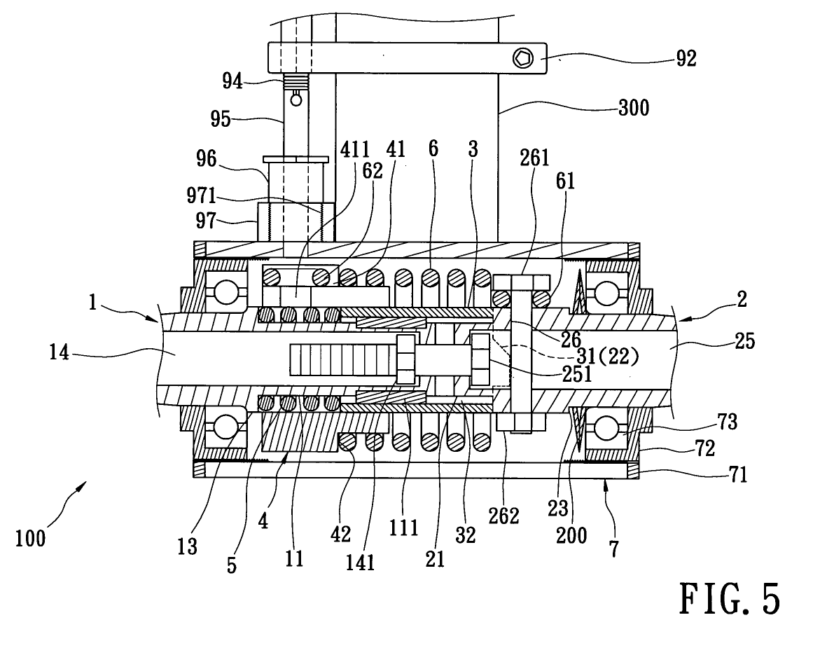

As shown in FIG. 5, the first spring 5 is telescoped on the telescoping portion 11 of the first shaft 1. The first busing 3 is telescoped on the telescoping portions 11 and 21 between the first and second shafts 1 and 2 so that the guide bar 111 can be embedded in the guide groove 32. The wedge bodies 22 and 31 of the second shaft 2 and the first bushing 3 mesh with each other. The first spring 5 is elastically retained between the flange 13 of the first shaft 1 and the thicker side of the first bushing 3. The main shaft 100 is thus formed.

The main shaft 100 can further comprises a screw nut 141 and a screw 251. The screw nut 141 is received in the receiving room 14 of the first shaft 1. The screw 251 can be inserted into the receiving room 25 from the outer end of the second shaft 2 so that the screw 251 can penetrate into the receiving room 14 of the first shaft 1 and be screwed into the screw nut 141. Each part of the main shaft 100 can thus be positioned to facilitate installation of the main shaft 1 in the shaft tube 7.

The second bushing 4 has a recessed portion 4 formed at the outer periphery thereof, a through hole 411 penetrating the recessed portion 41, and a drop portion 42 formed at the thicker side of one end thereof. The second bushing 4 is telescoped on the main shaft 100.

Ring bodies 61 and 62 are formed at two ends of the second spring 6, respectively. The second spring 6 is telescoped on the main shaft 100. The ring body 62 is embedded in the recessed portion 41 of the second bushing 4. The ring body 61 corresponds to the through hole 26 of the second shaft 2. A fastening component 261 is used to fix the ring body 61 on the second shaft 2. In other words, one end of the second spring 6 is fixed at the main shaft 100, and the other end thereof is fixed at the second bushing 4. The second bushing 4 is loosely matched with the main shaft 100. The left end of the second spring 6, excluding the ring body 62, abuts the drop portion 42 of the second bushing 4. If the fastening component 261 is a screw, a fastened component 262 (a screw but) is also required.

The outer periphery of the side cover 72 has an outer thread corresponding to an inner thread on the inner wall of each end of the shaft tube 7. The two side covers 72 can thus be screwed at two ends of the shaft tube 7. One side of the side cover 72 has a polygonal body 721, and the other side thereof forms a receiving room 722.

The bearing 3 is received in the receiving room 722 of the side cover 72 so that the first and second shafts 1 and 2 can protrude out from two ends of the shaft tube 7 through the bearing 73 and the side cover 72. The main shaft 100 can thus rotate. As shown in FIG. 1, one end of the two cranks 81 is screwed to the screwing portions 12 and 24 of the first and second shafts 1 and 2 through screw nuts 811 so that the two cranks 81 can be firmly connected at two ends of the first and second shafts 1 and 2. A buffer 200 is arranged between the drop portion 23 and the bearing 73. The buffer 200 can be a shock-absorbing spring.

The fastening ring 71 having an inner thread is screwed with the outer thread at the outer periphery of the side cover 72 to position the side cover 72.

As shown in FIGS. 1,3 and 5, the braking unit 9 comprises a steering component 91, a steel rope 93, an insertion rod 95 and a base portion 97 having an insertion hole 971. The steering component 91 is arranged on the handle of the bicycle. The steel rope 93 passes through an outer tube to form a steering wire set similar to a conventional braking wire. The steering wire set is fixed to a bicycle body support tube by a clip ring 92. The steel rope 93 is connected between the steering component 91 and a block body 931. The block body 931 is embedded in a cavity 951 in an end of the insertion rod 95. An elastic component 94 is arranged between the insertion rod 95 and the clip ring 92 to allow the insertion rod 95 to stick elastically downwards. The base portion 97 is formed on the shaft tube 7. The insertion hole 971 is connected to the shaft tube 7.

The braking unit 9 can further comprise a hollow insertion rod bushing 96 having an outer thread, and the insertion hole 971 of the base portion 97 has an inner thread so that the insertion rod bushing 96 can be screwed into the insertion hole 971 of the base portion 97.

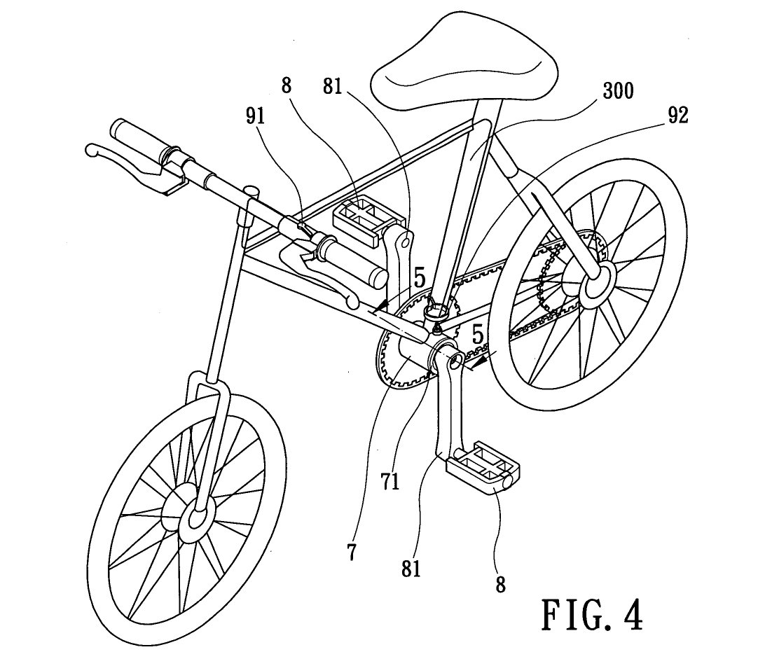

FIGS. 4 and 5 illustrate the conventional 360 degree circular rotation pedaling function of a bicycle, in which the main shaft 100 of the shaft rotates as a conventional main shaft, and the second bushing 4 and the second spring 6 simultaneously rotate freely.

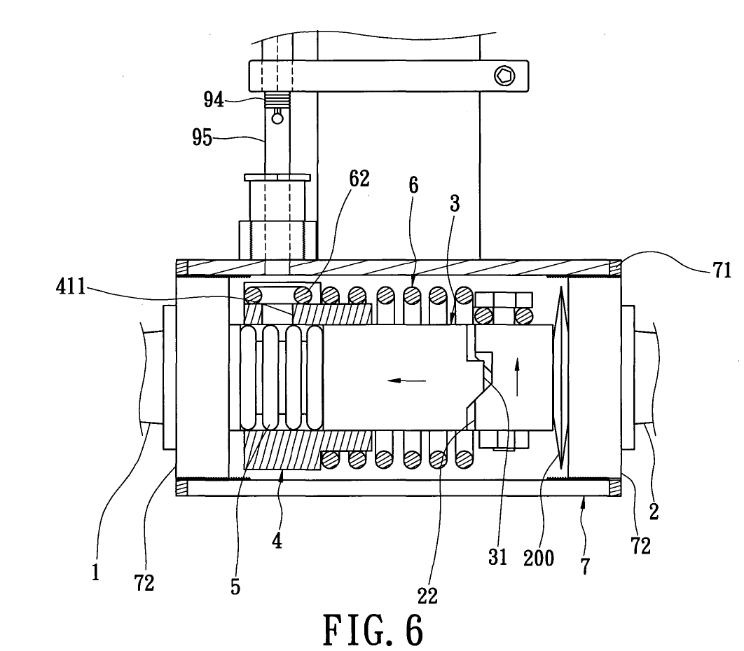

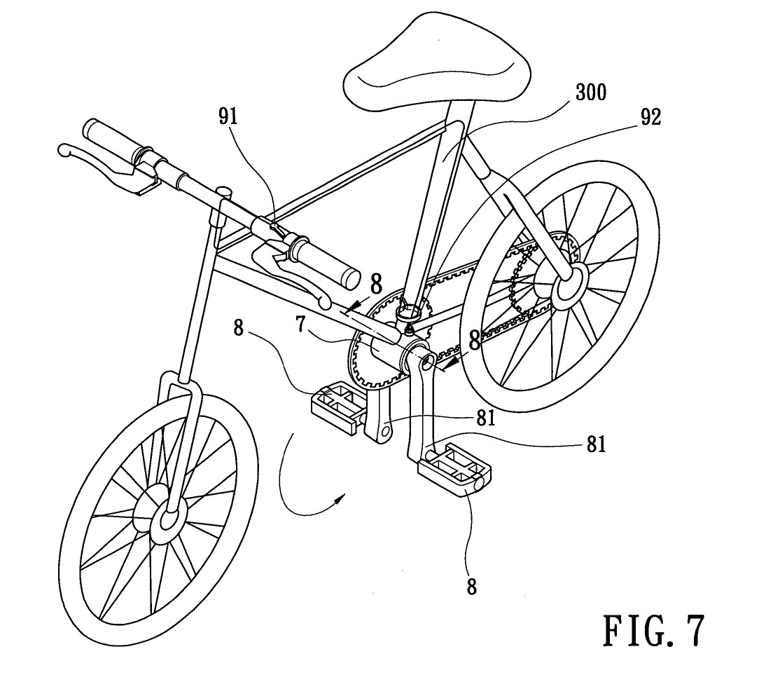

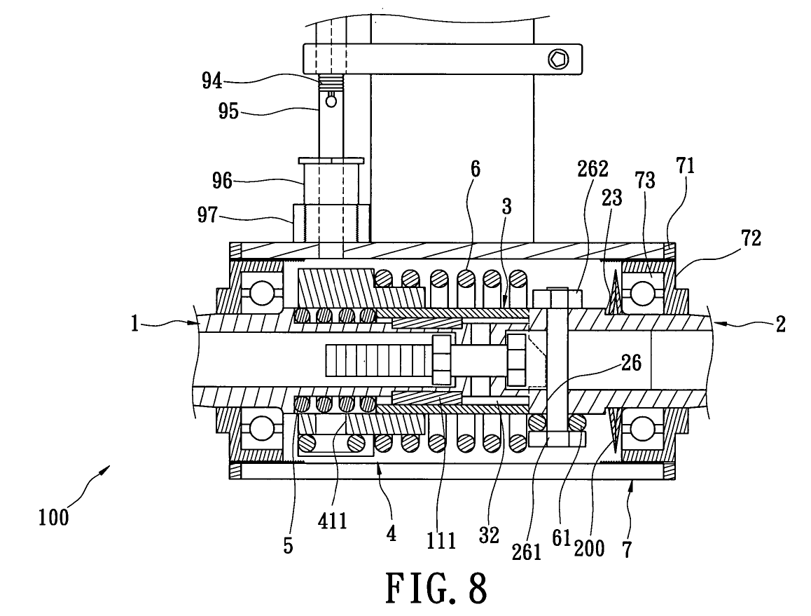

As shown in FIG. 6, in order to switch to a special pedaling function, the rider stops the lower left pedal 8 with his left foot and pedals forwards on the upper right pedal 8 with his right foot. Initially, as shown in FIG. 6, the wedge body 22 of the second shaft 2 is separated from the adjacent wedge body 31 to push the first bushing 3 leftwards and let the first spring elastically shrink therewith. The second spring 6 and the second bushing 4 synchronously idle. As shown in FIGS. 7 and 8, after the right pedal is pedaled forwards 180 degrees (both the two pedals 8 are at the lower position), the wedge body 22 can again mesh with the wedge body 31 after rotating 180 degrees so that the first bushing 3 can be pushed rightwards for restoration to its original position by the first spring 5. The generated instantaneous shock force can be absorbed by the buffer 200 to prevent the shaft structure from being damaged.

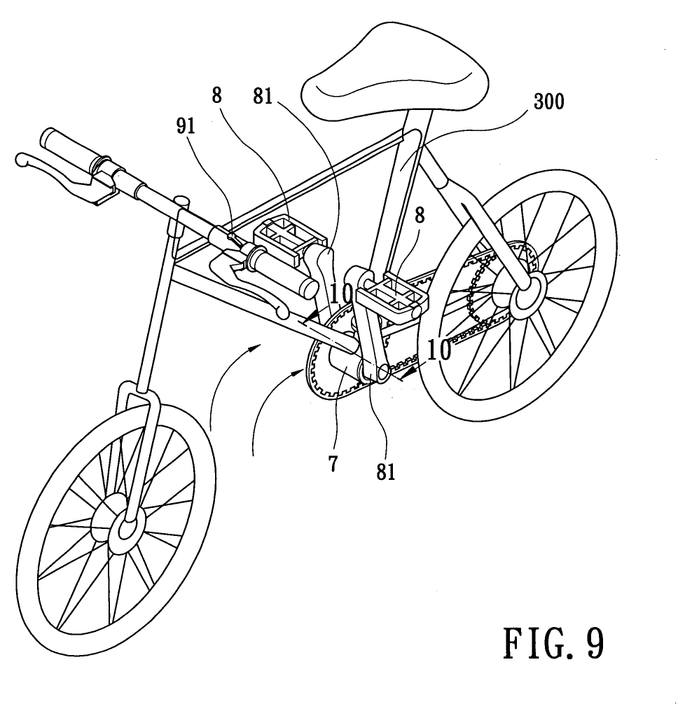

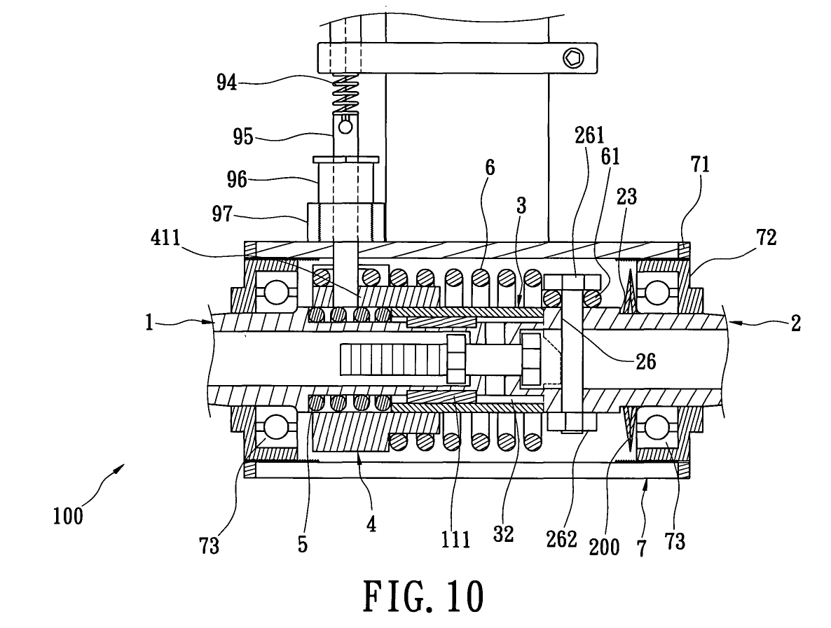

As shown in FIGS. 9 and 10, the rider hooks the two pedals at the lower position back 180 degrees with his foot insteps to let both the two pedals 8 be in the upper position. At this time, the steering component 91 and the elastic component 94 of the braking unit 9 are controlled to let the insertion rod 95 be inserted into the through hole 411 of the second bushing 4 and the ring body 62 of the second spring 6. The second busing 4 and the second spring 6 are limited by the insertion rod 95, and do not rotate along with the main shaft 200. The two pedals 8 at the upper position are in a state to be pedaled at this time. The height of the recessed portion 41 of the second bushing 4 is preferably larger than (or equal to) the thickness of the whole ring body 62 of the second spring 6 to facilitate insertion of the insertion rod 95 into the insertion hole 971.

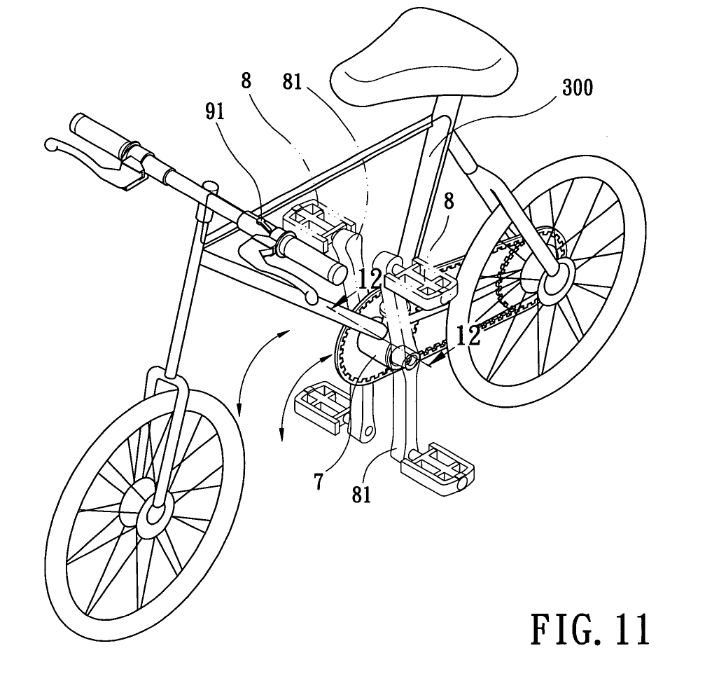

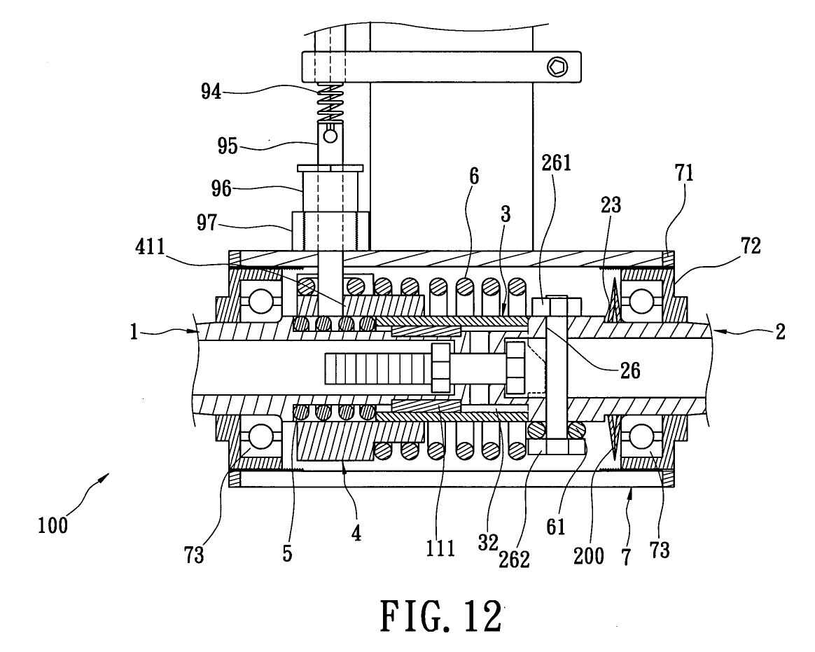

As shown in FIGS. 11 and 12, when the rider simultaneously pedals downwards on the two pedals 8 at the state to be pedaled, the main shaft 100 brings the ring body 61 of the second spring 6 to rotate axially forwards. Because the ring body 62 of the second spring 6 does not axially rotate forward, an elastic torsion is formed to let the second spring 6 generate an elastic restoration force, which allows elastic restoration of the two pedals 8 in the lower position elastically to the original upper position. The second pedaling function of the present invention can thus be accomplished.

If the bicycle is to be restored to the common pedaling function, it is only necessary to draw back the insertion rod 95 of the braking unit 9, limit the left pedal 8 with the left foot, and then pedal forwards on the right pedal 8 180 degrees with the right foot to restore the right and left pedals to the original one-up-one-down state. The rider can then ride the bicycle forwards in the conventional manner. The present invention has the following characteristics:

1. A bicycle can have both a conventional 360-degree circular rotation pedaling function and a special same-up-same-down pedaling function. A rider can switch between the two functions to have much variation. Moreover, the second pedaling function can be entertaining.

2. The parts that may suffer elasticity fatigue can be adjusted externally.

As shown in FIGS. 1 and 5, polygonal portions 15 and 27 can further be added to the first and second shafts 1 and 2. The polygonal portion 15 is located between the screwing portion 23 and the flange 13. The polygonal portion 27 is located between the drop portion 23 and the screwing portion 24. The peripheral profile of the polygonal portions 15 and 27 is composed of a plurality of axial tangent planes. One end of the cranks 81 are telescoped with the polygonal portions 15 and 27 and meshed with the tangent planes of the polygonal portions for positioning. Finally, screw nuts 811 are screwed to the screwing portions 12 and 24 for preventing the cranks 81 from coming off in the reverse direction. Therefore, when the first spring is elastically fatigued to cause a drop of angle between the crank 81 and the shaft (the angle from the lower end to the lower end is smaller than 180 degrees), one can adjust the meshed angle between the crank 81 and the polygonal portion 15 or 27 to adjust back the drop of angle generated by elasticity fatigue, hence accomplishing the object of external adjustment. Similarly, the user can adjust externally according to his predilection for elasticity.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A pedal shaft structure of a bicycle having a second pedaling function, said bicycle having a shaft tube with a braking unit and a shaft, a crank being arranged at each end of said shaft, a pedal being arranged at the other end of each of said crank, said shaft comprising;
a main shaft comprising a first shaft with a guide bar, a second shaft with a wedge body, a first bushing with a wedge body and a guide groove, and a first spring, said first bushing being telescoped between said first shaft and said second shaft, said guide bar being embedded in said guide groove, said first spring being telescoped at said first shaft and elastically retained between said first bushing and said first shaft, said two wedge bodies being meshed together;
a second spring telescoped at said main shaft, one end of said second spring being fixed at said second shaft; and
a pair of bearings arranged at two ends of said shaft tube and telescoped at two ends of said main shaft, respectively;
said braking unit comprising an insertion hole formed at said shaft tube, an insertion rod inserted into said insertion hole, a steering component, a steel rope connected between said steering component and said insertion rod, said insertion rod being further inserted into the other end of said second spring for fixation after inserted into said insertion hole.

2. The pedal shaft structure of a bicycle having a second pedaling function as claimed in claim 1, wherein both said wedge body of said second shaft and said wedge body of said first bushing comprise two wedge-shaped protuberances and two wedge-shaped recessed bodies and are meshed together.

3. The pedal shaft structure of a bicycle having a second pedaling function as claimed in claim 1, wherein said shaft further comprises a second bushing telescoped at said main shaft, a recessed portion is arranged on said second bushing, said recessed portion has a through hole corresponding to said insertion rod, and the other end of said second spring has a ring body embedded in said recessed portion.

4. The pedal shaft structure of a bicycle having a second pedaling function as claimed in claim 3, wherein a height of said recessed portion of said second bushing is greater than a thickness of said ring body of said second spring.

5. The pedal shaft structure of a bicycle having a second pedaling function as claimed in claim 1, wherein said main shaft further comprises a screw nut and a screw, said first and second shafts of said main shaft have hollow receiving rooms, said screw nut and said screw are received in said receiving rooms of said first and second shafts, and said screw penetrates into said receiving room of said first shaft to be screwed into said screw nut.

6. The pedal shaft structure of a bicycle having a second pedaling function as claimed in claim 1, wherein said shaft further comprises a buffer located between said bearing and said second shaft.

7. The pedal shaft structure of a bicycle having a second pedaling function as claimed in claim 1, wherein said braking unit further comprises a clip ring and an elastic component, said clip ring is clamped to said bicycle to position said steel rope, and said elastic component telescopes on said steel rope and is elastically retained between said clip ring and said insertion rod.

8. The pedal shaft structure of a bicycle having a second pedaling function as claimed in claim 1, wherein one end of said steel rope further has a block body, a cavity is arranged at one end of said insertion rod, and said block body of said steel rope is embedded in said cavity of said insertion rod.

9. The pedal shaft structure of a bicycle having a second pedaling function as claimed in claim 1, wherein said braking unit further comprises a base portion formed at said shaft tube and a hollow insertion rod bushing, said base portion has said insertion hole having an inner thread and connected to said shaft tube, and said insertion rod bushing having an outer thread is screwed into said insertion hole of said base portion.
